(19) United States
(12) Patent Application Publication
(10) Pub. No.: US 2013/0169542 A1
(43) Pub. Date: Jul. 4, 2013

(54) METHOD FOR UNLOCKING TERMINAL DEVICE AND TERMINAL DEVICE

(71) Applicant: Huawel Technologies Co., Ltd, Shenzhen (CN)

(72) Inventors: Yi Lu, Shenzhen (CN); Leilei Cao, Shenzhen (CN)

(73) Assignee: Huawel Technologies Co., Ltd, Shenzhen (CN)

(21) Appl. No.: 13/728,850

(22) Filed: Dec. 27, 2012

Related U.S. Application Data
(63) Continuation of application No. PCT/CN2011/084801, filed on Dec. 28, 2011.

(51) Int. Cl. G06F 3/01; G06F 3/041; G06F 3/02

(52) U.S. Cl. CPC G06F 3/017; G06F 3/02; G06F 3/041
USPC 345/168; 345/156; 345/173

(57) ABSTRACT

A method for unlocking a terminal device and a terminal device are provided. When a terminal device is in lock mode, the terminal device obtains a rhythm with which a user taps the terminal device, and if the obtained rhythm is a preset unlock rhythm, the terminal device is enabled to perform an unlock operation.

### CROSS-REFERENCE TO RELATED APPLICATIONS

This application is a continuation of International Application No. PCT/CN2011/084801, filed Dec. 28, 2011, titled “METHOD FOR UNLOCKING TERMINAL DEVICE AND TERMINAL DEVICE”, which is herein incorporated by reference in its entirety.

### TECHNICAL FIELD

The present disclosure relates to unlock technologies, and in particular, to a method for unlocking a terminal device and a terminal device.

### BACKGROUND

To prevent a terminal device from unexpected startup, the terminal device may be locked so that it works in lock mode. When a terminal device in lock mode is to be started, the screen of the terminal device needs to be firstly activated, an unlock operation is performed according to unlock information displayed on the screen or is performed by directly sliding with a specific gesture (that is, an unlock gesture) on the touch screen to enable the terminal device to enter unlock mode (that is, normal work mode).

In the prior art, the unlock operation may be performed depending on the unlock information displayed on the screen or the obtained unlock gesture, so that it takes a long time to perform the unlock operation and the unlock efficiency is reduced.

### SUMMARY

Embodiments of the present invention provide a method for unlocking a terminal device and a terminal device, for improving the unlock efficiency.

In one aspect, a method for unlocking a terminal device is provided, including:

when a terminal device is in lock mode, obtaining, by the terminal device, a rhythm with which a user taps the terminal device; and

if the obtained rhythm is a preset unlock rhythm, performing, by the terminal device, an unlock operation to enable the terminal device to enter unlock mode.

In another aspect, a terminal device is provided, including:

an obtaining unit, configured to, when the terminal device is in lock mode, obtain a rhythm with which a user taps the terminal device; and

an unlocking unit, configured to, if the rhythm obtained by the obtaining unit is a preset unlock rhythm, perform an unlock operation to enable the terminal device to enter unlock mode.

It can be known from the above, according to the some embodiments of the present invention, when the terminal device is in the lock mode, the terminal device obtains the rhythm with which the user taps the terminal device, and if the obtained rhythm is the preset unlock rhythm, the terminal device performs the unlock operation. The unlock operation can be performed without depending on the unlock information displayed on the screen (touch screen or non-touch screen) or the obtained unlock gesture. This effectively reduces the time needed for the unlock operation, and improves the unlock efficiency.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description show some embodiments of the present invention, and persons of ordinary skill in the art can derive other drawings from these accompanying drawings without creative efforts.

FIG. 1 is a schematic flowchart of a method for unlocking a terminal device according to an embodiment of the present invention;

FIG. 2 is a schematic structural diagram of a terminal device according to another embodiment of the present invention; and

FIG. 3 is a schematic structural diagram of a terminal device according to another embodiment of the present invention.

### DETAILED DESCRIPTION

To make the objectives, technical solutions, and advantages of the present invention more comprehensible, the following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative efforts shall fall within the protection scope of the present invention.

It should be noted that, the terminal device involved in the embodiments of the present invention may include, but not limited to, a mobile phone, a personal digital assistant (Personal Digital Assistant, abbreviated to PDA), a wireless handheld device, a wireless notebook, a laptop, an MP3 player or an MP4 player.

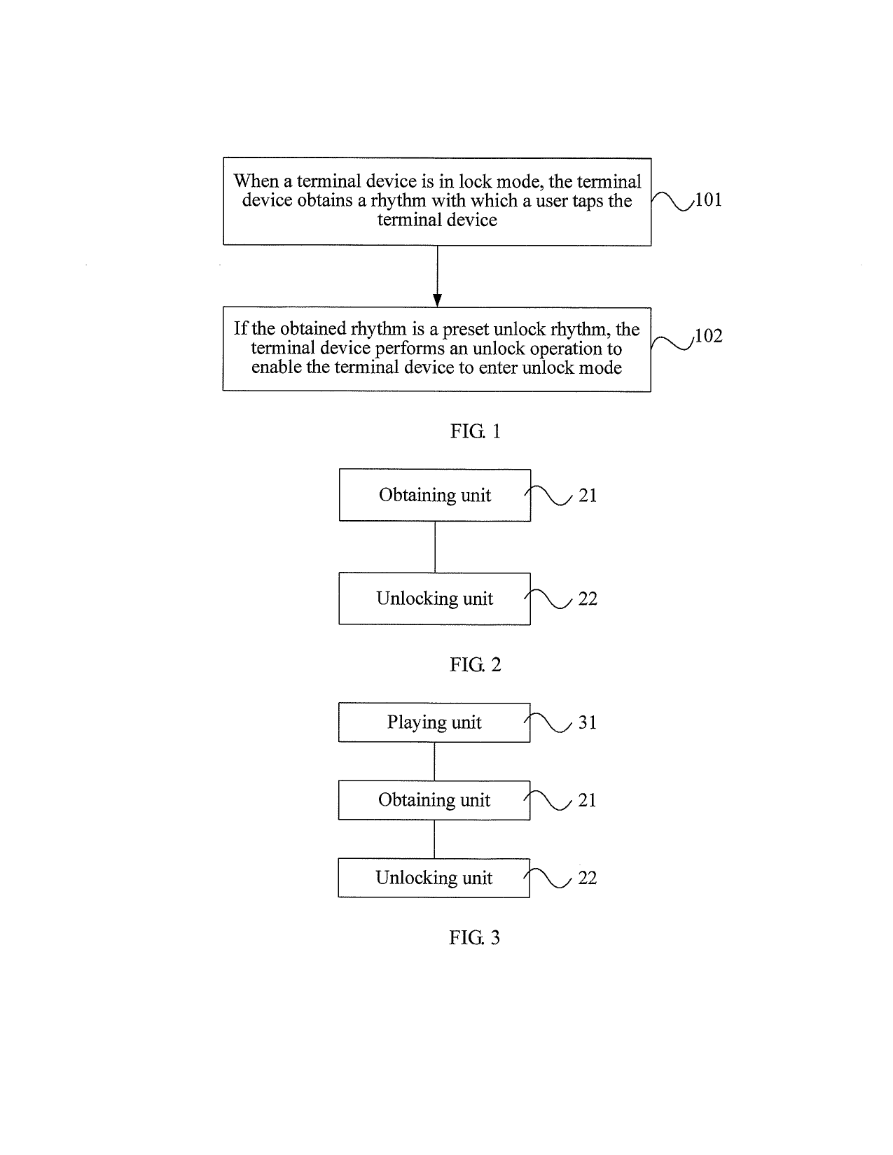

FIG. 1 is a schematic flowchart of a method for unlocking a terminal device according to an embodiment of the present invention. As shown in FIG. 1, the method for unlocking the terminal device according to this embodiment may include:

101. When a terminal device is in lock mode, the terminal device obtains a rhythm with which a user taps the terminal device.

The rhythm with which the user taps the terminal device may include, but not limited to, at least one of speed and strength at which the user taps the terminal device, which is not limited in this embodiment.

102. If the obtained rhythm is a preset unlock rhythm, the terminal device performs an unlock operation to enable the terminal device to enter unlock mode.

In an application scenario of the embodiment of the present invention, the terminal device may be a touch screen terminal. Correspondingly, a user can trigger, by tapping the touch screen, the touch screen terminal to perform the unlock operation. For example, in 101, when the touch screen terminal is in the lock mode, the touch screen terminal may obtain the rhythm with which the user taps the touch screen.

In another application scenario of the embodiment of the present invention, the terminal device may be a keypad terminal. Correspondingly, a user can trigger, by tapping the keypad, the keypad terminal to perform the unlock operation. For example, in 101, when the keypad terminal is in the lock mode, the keypad terminal may obtain the rhythm with which the user taps the keypad.

It can be understood that before 101 is performed, the terminal device needs to firstly activate the touch screen of the touch screen terminal or the keypad of the keypad terminal in the lock mode.

Alternatively, after 101 is performed, the terminal device may further play, according to the obtained rhythm, at least one of an audio file and a video file that correspond to the rhythm.

In this embodiment, different rhythms may be set to define different commands. It may be understood that a mapping table between rhythms and commands is set, and when identifying one of the rhythms, the terminal device may obtain the command corresponding to the rhythm by querying in the mapping table, so that the terminal device is unlocked according to this command. In this embodiment, the command may be parsed by an unlocking unit set in the terminal device. When the parsing result shows that this command is an unlock command, the terminal device is unlocked.

In this embodiment, when the terminal device is in the lock mode, the terminal device obtains the rhythm with which the user taps the terminal device, and if the obtained rhythm is the preset unlock rhythm, the terminal device is enabled to perform the unlock operation. With the method for unlocking the terminal device provided in this embodiment, the unlock operation can be performed without depending on the unlock information displayed on the screen (touch screen or non-touch screen) or the obtained unlock gesture. This effectively reduces the time needed for the unlock operation, and improves the unlock efficiency.

With the method for unlocking the terminal device provided in this embodiment, in some special scenarios, a user may conveniently unlocks a mobile phone. For example, when the user is driving a car and desires to make a call to his or her friend, it is hard for him or her to unlock the mobile phone with one hand according to the unlocking method disclosed in the prior art, while holding the steering wheel with the other hand and observing road conditions and traffic ahead at the same time. However, the user may take out the mobile phone with one hand, and taps the touch screen of the mobile phone to produce a single-syllable rhythm “dingding, dingding”. The mobile phone obtains the rhythm and successfully matches a preset unlock rhythm. In this way, the mobile phone may immediately perform the unlock operation, and the user may make a voice dial over the mobile phone.

With the method for unlocking the terminal device provided in this embodiment, the unlock operation may be triggered for the mobile phone only when the rhythm with which the mobile phone is tapped matches the preset unlock rhythm. This mode is similar to the case that a password is set by the user and the mobile phone may be unlocked only after the correct password is input. Accordingly, the unlocking method implemented by tapping the screen by the user integrates the function of unlocking the terminal device by a password, which further protects the privacy of the user.

With the method for unlocking the terminal device provided in this embodiment, the preset unlock rhythm may be rhythms of some simple songs, for example, rhythms of songs such as Ding Ding Dang and One Two Three Four. The tapping rhythms are simple and easy to memorize. In addition, at least one of an audio file and a video file that correspond to the above rhythm is played according to the tapping rhythm, which further improves the user experience.

It should be noted that, for brevity, the above method embodiments are represented as a series of actions. But persons skilled in the art should appreciate that the present invention is not limited to the order of the described actions, because according to the present invention, some steps may be performed in other orders or performed simultaneously. It should be further understood by persons skilled in the art that the described embodiments all belong to exemplary embodiments, and the involved actions and modules are not necessarily required by the present invention.

In the above embodiments, the description of each embodiment has its emphasis, and for the parts that are not detailed in some embodiment, reference may be made to the relevant description of the other embodiments.

FIG. 2 is a schematic structural diagram of a terminal device according to another embodiment of the present invention. As shown in FIG. 2, the terminal device according to this embodiment may include an obtaining unit 21 and an unlocking unit 22. The obtaining unit 21 is configured to, when the terminal device is in lock mode, obtain a rhythm with which a user taps the terminal device; and the unlocking unit 22 is configured to, if the rhythm obtained by the obtaining unit 21 is a preset unlock rhythm, perform an unlock operation to enable the terminal device to enter unlock mode.

The functions of the terminal device illustrated in the embodiment corresponding to FIG. 1 may be implemented by the terminal device provided in this embodiment.

In an application scenario of the embodiment of the present invention, the terminal device may be a touch screen terminal. Correspondingly, a user can trigger, by tapping a touch screen, the touch screen terminal to perform the unlock operation. For example, the obtaining unit 21 may specifically obtain, when the touch screen terminal is in the lock mode, the rhythm with which the user taps the touch screen.

In another application scenario of the embodiment of the present invention, the terminal device may be a keypad terminal. Correspondingly, a user can trigger, by tapping a keypad, the keypad terminal to perform the unlock operation. For example, the obtaining unit 21 may specifically obtain, when the keypad terminal is in the lock mode, the rhythm with which the user taps the keypad.

Alternatively, as shown in FIG. 3, the terminal device provided in this embodiment may further include a playing unit 31, configured to play, according to the rhythm obtained by the obtaining unit 21, at least one of an audio file and a video file that correspond to the rhythm.

In this embodiment, when the terminal device is in the lock mode, the obtaining unit obtains the rhythm with which the user taps the terminal device, and if the rhythm obtained by the obtaining unit is the preset unlock rhythm, the unlocking unit is enabled to perform the unlock operation. With the method for unlocking the terminal device provided in this embodiment, the unlock operation can be performed without depending on the unlock information displayed on the screen (touch screen or non-touch screen) or the obtained unlock gesture. This effectively reduces the time needed for the unlock operation, and improves the unlock efficiency.

It can be clearly understood by persons skilled in the art that, for the purpose of convenient and brief description, for a detailed working process of the foregoing system, apparatus and unit, reference may be made to the corresponding process in the method embodiments, and the details will not be described herein again.

In the embodiments provided in the present application, it should be understood that the disclosed system, apparatus, and method may be implemented in other modes. For example, the described apparatus embodiments are merely exemplary. For example, the units are merely divided according to logical functions and can be divided in other manners in actual implementation. For example, multiple units or components can be combined or integrated into another system, or some features can be ignored or not performed. In addition, the displayed or discussed mutual couplings or direct couplings or communication connections are implemented through some interfaces. The indirect couplings or communication connections between the apparatuses or units may be implemented in electrical, mechanical or other forms.

The units described as separate parts may or may not be physically separated, and parts displayed as units may or may not be physical units, that is, may be integrated or distributed to multiple network elements. A part or all of the units may be selected according to the actual needs to achieve the objectives of the solutions of the embodiments.

In addition, functional units in the embodiments of the present invention may be integrated into one processing unit or exist as separate physical units, or two or more units are integrated into one unit. The integrated unit may be implemented through hardware, or may also be implemented in a form of hardware plus a software functional unit.

The integrated unit implemented in the form of the software functional unit may be stored in a computer readable storage medium. The software functional unit is stored in a storage medium, and contains several instructions used to instruct computer equipment (for example, a personal computer, a server, or network equipment) to perform a part of the steps of the methods according to the embodiments of the present invention. The storage medium may be any medium that can store program codes, such as a USB flash drive, a removable hard disk, a read-only memory (Read-Only memory, ROM), a random access memory (Random Access Memory, RAM), a magnetic disk, or an optical disk.

Finally, it should be noted that the foregoing embodiments of the present invention are intended for describing the technical solutions of the present invention, instead of limiting the present invention. Although the present invention is described in detail with reference to the foregoing embodiments, persons of ordinary skill in the art should understand that they can still make modifications to the technical solutions described in the foregoing embodiments, or make equivalent substitutions to some technical features thereof, without departing from the spirit and scope of the technical solutions of the embodiments of the present invention.

What is claimed is:

1. A method for unlocking a terminal device, the method comprising:
when the terminal device is in a lock mode, obtaining, by the terminal device, a rhythm with which a user taps the terminal device; and
if the obtained rhythm is a preset unlock rhythm, performing, by the terminal device, an unlock operation to enable the terminal device to enter an unlock mode.

2. The method according to claim 1, wherein the terminal device is a touch screen terminal, and the obtaining comprises:
obtaining, by the touch screen terminal, the rhythm with which the user taps a touch screen of the touch screen terminal.

3. The method according to claim 1, wherein the terminal device is a keypad terminal, and the obtaining comprises:
obtaining, by the keypad terminal, the rhythm with which the user taps a keypad of the keypad terminal.

4. The method according to claim 1, further comprising:
playing, by the terminal device, according to the obtained rhythm, at least one of an audio file and a video file that correspond to the rhythm.

5. The method according to claim 1, wherein the rhythm comprises at least one of speed and strength at which the user taps the terminal device.

6. A terminal device, comprising:
an obtaining unit configured to obtain a rhythm with which a user taps the terminal device when the terminal device is in a lock mode; and
an unlocking unit configured to perform an unlock operation to enable the terminal device to enter an unlock mode if the rhythm obtained is a preset unlock rhythm.

7. The terminal device according to claim 6, wherein the terminal device is a touch screen terminal, and the obtaining unit is configured to:
obtain the rhythm with which the user taps a touch screen of the touch screen terminal when the touch screen terminal is in the lock mode.

8. The terminal device according to claim 6, wherein the terminal device is a keypad terminal, and the obtaining unit is configured to:
obtain the rhythm with which the user taps a keypad of the keypad terminal when the keypad terminal is in the lock mode.

9. The terminal device according to claim 6, wherein the terminal device further comprises a playing unit, configured to:
play, according to the rhythm obtained by the obtaining unit, at least one of an audio file and a video file that correspond to the rhythm.
